(19) United States
(12) Patent Application Publication
(10) Pub. No.: US 2015/0285283 A1
(43) Pub. Date: Oct. 8, 2015

(54) DEVICE FOR ATTACHING AN OBJECT WITHIN A RAIL OF A SUPPORT

(71) Applicant: ATTAX, Carrieres Sur Seine (FR)

(72) Inventor: Romain Danet, Maisons-Laffitte (FR)

(21) Appl. No.: 14/680,939

(22) Filed: Apr. 7, 2015

(30) Foreign Application Priority Data
Apr. 7, 2014 (FR) 14 53054

(51) Int. Cl. F16B 2/06; B64D 11/06; F16B 2/18

(52) U.S. Cl. CPC F16B 2/06; F16B 2/185; B64D 11/0696

(57) ABSTRACT

A device for attaching an object within a rail of a support is provided. The device includes a base designed to bear on the rail. The base includes a jaw for gripping the base on the rail. The device further includes a screw/nut device for tightening/loosening the base on the rail while one end of the screw/nut device is connected to a maneuvering device for an operator to tighten/loosen the device. The maneuvering device includes a lever that can be moved between a retracted storage position and an active position while allowing the operator to tighten/loosen the device.

### BACKGROUND

The present invention relates to a device for attaching an object within a rail of a support.

Such attaching devices for example have already been used to attach objects such as seats or other objects on or within rails of a support for example made up of an airplane floor, motor vehicle floor, etc.

In general, such devices for example comprise a base designed to be placed or bearing on or below the rail and which comprises a screw/nut device for tightening the latter on the rail so as to lock the object in position.

Such a screw/nut device for example comprises a rod associated with a threaded part or which itself is threaded, engaged in a tapped hole of the base. One end of the rod comprises a tightening heel designed to be placed below the rail to tighten the latter between that heel and the base. At another end, the rod comprises a device for maneuvering that rod to allow it to be tightened or loosened, for example by an operator.

This maneuvering device for example comprises lateral protruding portions or a cavity for a tool, allowing an operator to tighten or loosen the device manually.

However, these devices have a certain number of drawbacks in terms of separation risks of the assembly, for example due to incorrect manipulations or vibrations encountered in this type of application.

In addition, these devices are relatively difficult to maneuver.

The aim of the invention is therefore to resolve these problems.

### SUMMARY

To that end, the invention relates to a device for attaching an object within a rail of a support, comprising a base designed to bear on the rail, said base comprising a jaw for gripping the base on the rail, the device further comprising a screw/nut device for tightening/loosening the base on the rail, one end of the screw/nut device being connected to a maneuvering device for an operator to tighten/loosen the device, wherein the maneuvering device comprises a lever able to be moved between a retracted storage position and an active position allowing the operator to tighten/loosen the device.

According to other advantageous features of the device according to the invention, considered alone or in combination:

at one end, the lever comprises a yoke articulated to the end of a tightening/loosening rod of the jaw;

the articulated yoke allows a predetermined angular travel of the lever relative to the tightening/loosening rod;

the yoke comprises a tapped portion suitable for cooperating with the ends of an articulation rod crossing through the tightening/loosening rod;

the tapped portion of the yoke has a different pitch opposite that of a tapped portion of the screw/nut device.

The invention also relates to an assembly comprising an attachment device as previously described and a rail able to be assembled to said attachment device and a support.

The invention also relates to an assembly comprising an attachment device as previously described and an object able to be attached to a support by said device, the object being a seat.

The invention also relates to an assembly comprising an attachment device as previously described, a rail able to be assembled to said attachment device and a support assembled to said rail, the support being an aircraft floor.

### BRIEF DESCRIPTION OF THE DRAWINGS

Embodiments of the present invention will be better understood using the following description, provided solely as an example and done in reference to the appended drawings, in which:

FIGS. 1 and 2 show perspective views of an attachment device according to one embodiment of the invention, in which a maneuvering lever is diagrammatically shown in the retracted storage and locking/blocking position and an active position for tightening/loosening of the device by an operator;

FIG. 3 shows an end view of the device of FIG. 1, illustrating the placement thereof within a rail of a support; and

FIG. 4 shows a cross-sectional view of the device of FIGS. 1 and 2, illustrating the structure and operation of such a device.

### DETAILED DESCRIPTION

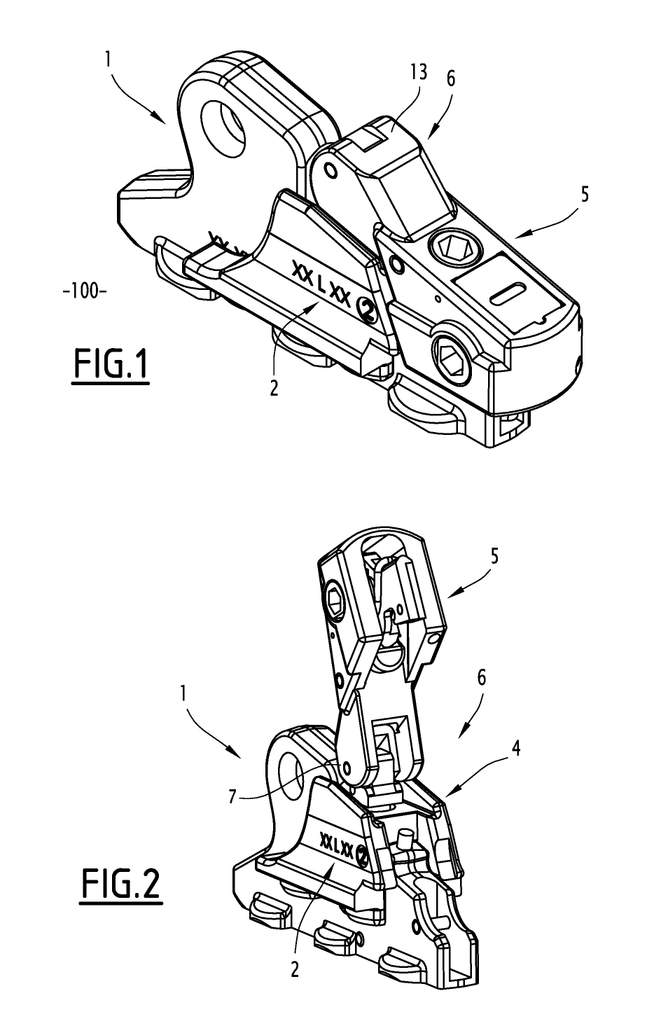

FIGS. 1 to 3 show a device 100 for attaching an object on a rail of a support.

The object is for example made up of an aircraft seat or any other object designed to be attached on the floor thereof.

Of course, other supports may be considered, such as a motor vehicle floor.

The attachment device 100 comprises a base 1 on which a gripping jaw 2 is mounted.

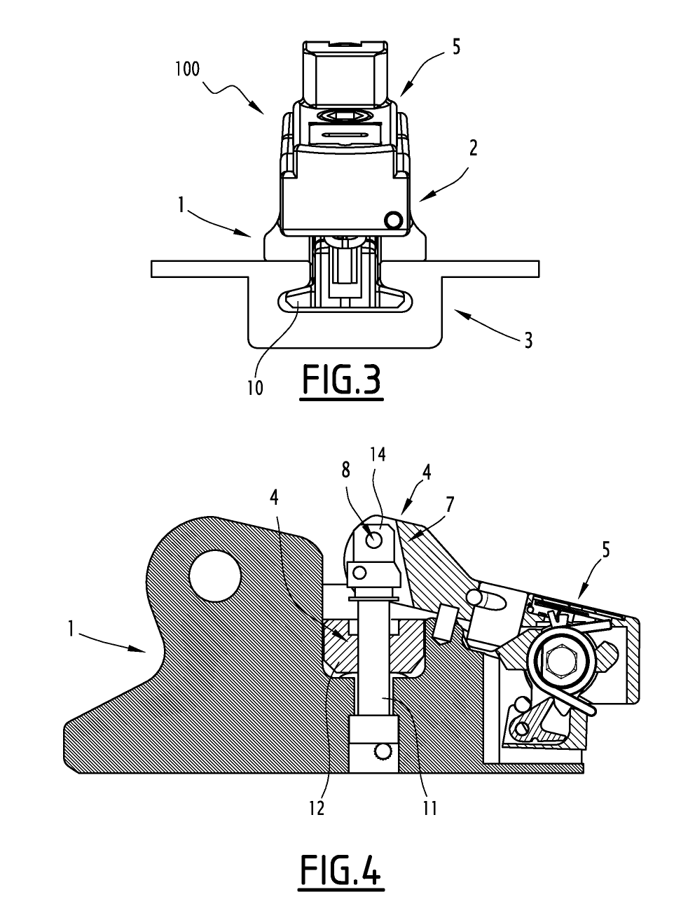

As illustrated in FIG. 3, the gripping jaw 2 makes it possible to grip the attachment device 100 on a rail 3, by gripping the jaw 2 against the rail 3. The base 1 comprises portions 10 in the form of a tightening heel, suitable for engaging within the rail 3 and to bear thereon.

In the tightening position of the device, the rail 3 is then pinched between the heels 10 of base and the jaw 2.

A screw/nut device 4 is preferably interposed between the base 1 and the gripping jaw 2. As illustrated in FIG. 4, the screw/nut device 4 for example comprises a threaded rod 11 forming a screw and a tapped portion 12 forming a nut.

The screw/nut device 4 can be maneuvered by an operator using a maneuvering lever 5. One end 13 of the lever 5 is assembled to one end 14 of the screw 11.

The lever 5 can be moved by pivoting between a retracted storage position and an active position for being maneuvered by the operator, illustrated in FIGS. 1 and 2, respectively.

In the retracted storage position, the lever 5 is locked in position. In the active position, the operator can grasp the lever and rotate it in either direction to maneuver the screw/nut device 4. The operator can thus tighten or loosen the jaw 2 on the base 1.

In the retracted storage position, the lever 5 is for example locked in position using a hook, traditionally and as is known.

At its end 13 associated with the screw 11, the lever 5 is for example equipped with an articulation yoke 6 on the corresponding end 14 of the screw 11.

The yoke 6 allows a certain angular travel of the lever 5 relative to the end 14 of the screw-forming rod 11. This allows the operator first to tighten the device 100, then second to orient the lever 5 in the correct angular position to move it into the retracted and locking position.

This angular travel, or dead or free travel, is essential: based on the gripping of the jaw 2 against the rail 3, the lever 5 cannot be found in the angular position illustrated in FIGS. 1 and 2, allowing the operator to move said lever toward its retracted storage position.

The possible angular travel between the lever 5 and the end 14 of the rod makes it possible to resolve this problem.

In order to allow this angular travel, the device 100 comprises a tapped portion 7 in the yoke 6, said tapped portion 7 being suitable for cooperating with the ends of an articulation rod 8. The articulation rod 8 crosses through the end 14 of the screw-forming threaded rod 11.

The pitch of this tapped portion 7 of the yoke 6 can be different from and opposite that of the tapped portion 12 of the screw/nut device 4 for gripping the jaw 2 on the base 1.

When the operator wishes to tighten or loosen the jaw 2, he must first rotate the lever 5 relative to the rod 6 to cover that so-called free or dead travel before bringing the lever into the abutting position. The operator can then actuate the rod 11 of the screw/nut device 4 for tightening/loosening.

Once the jaw 2 is in the gripping position and the rail 3 is pinched between the jaw 2 and the base 1, the device 100, and therefore the object, are locked in position on the floor. The operator can then return the lever 5 toward the retracted angular storage and locking position.

Of course, other embodiments can be considered.

What is claimed is:

1. An attachment device for attaching an object within a rail of a support, comprising:
a base designed to bear on the rail, said base comprising a jaw for gripping the base on the rail; and
a screw/nut device for tightening/loosening the base on the rail, one end of the screw/nut device being connected to a maneuvering device for an operator to tighten/loosen the device,
wherein the maneuvering device comprises a lever able to be moved between a retracted storage position and an active position allowing the operator to tighten/loosen the device.

2. The attachment device according to claim 1, wherein the screw/nut device for tightening/loosening the base on the rail comprises a tightening/loosening rod, the end of the screw/nut device connected to the maneuvering device being an end of said rod, and wherein one end of the lever comprises a yoke articulated to the end of said tightening/loosening rod.

3. The attachment device according to claim 2, wherein the articulated yoke allows a predetermined angular travel of the lever relative to the tightening/loosening rod.

4. The attachment device according to claim 3, wherein the yoke comprises a tapped portion suitable for cooperating with ends of an articulation rod crossing through the tightening/loosening rod.

5. The attachment device according to claim 4, wherein the tapped portion of the yoke has a different pitch opposite that of a tapped portion of the screw/nut device.

6. An assembly comprising the attachment device according to claim 1, further comprising a rail can be assembled to the attachment device, and a support.

7. The assembly according to claim 6, further comprising a seat that can be attached to the support by the attachment device.

8. The assembly according to claim 6, wherein the support assembled to the rail and the support is an aircraft floor.
